(19) United States
(12) Patent Application Publication
(10) Pub. No.: US 2008/0216968 A1
(43) Pub. Date: Sep. 11, 2008

(54) MODULAR STRIP DOOR SYSTEM

(76) Inventors: Rory Patrick Falato, West Chester, OH (US); Robert Joseph Clark, Cincinnati, OH (US)

Correspondence Address: FROST BROWN TODD, LLC, 2200 PNC CENTER, 201 E. FIFTH STREET, CINCINNATI, OH, 45202, US

(21) Appl. No.: 12/043,435

(22) Filed: Mar. 6, 2008

Related U.S. Application Data
(60) Provisional application No. 60/893,205, filed on Mar. 6, 2007.

(51) Int. Cl. E05D 15/26; E06B 5/00

(52) U.S. Cl. 160/200; 248/205.1

(57) ABSTRACT

A modular strip door system includes a plurality of strips, a bracket and a strip mounting member that may be assembled and placed adjacent to a door or opening. The strip mounting member is configured to retain the plurality of strips and be releasably mounted onto the bracket. The strip mounting member includes an upper channel and a lower channel configured to receive the plurality of strips. The strip mounting member further includes at least one bracket mounting aperture configured to receive at least one mounting protuberance projecting from the inner face of the bracket. In one alternate embodiment the system comprises a plurality of strips configured to be releasably mounted onto a bracket. In yet another alternate embodiment, the system comprises a strip mounting member configured to be mounted to a support surface and retain a plurality of strips.

### PRIORITY INFORMATION

The present invention claims priority of U.S. Provisional Patent Application 60/893,205 filed Mar. 6, 2007 the disclosure of which is incorporated by reference herein.

### BACKGROUND

Embodiments of the invention are related to the mounting of single and/or pre-assembled groups of strips of various widths and thickness for use as a door, curtain, wall or enclosure to create a thermal, visual or sound barrier. The strips may be clear, translucent, opaque, or have any other suitable configuration. The strips may comprise plastic, including, but not limited to, poly vinyl chloride (“PVC”), or any other suitable material. Embodiments of the invention may be designed to provide flexible and faster mounting options.

Current strip door product designs may require time consuming mounting methods. Many designs require the installer to follow a series of steps—installing brackets, hanging individual strips, maintaining the proper strip to strip overlap and attaching retaining hardware to account for different strip thickness. The replacement of individual strips usually requires partial disassembly of the mounting hardware.

One common mounting method uses a formed metal bracket with perpendicular, equally spaced, and threaded cylindrical posts. In one version the posts are spaced every two inches. Overlapping, individual plastic strips of various widths, thicknesses with matching, equally spaced round holes are then placed over the posts. The strips may be made of PVC. In this method, the strips are held in place with multi-post retaining plates, such as 12′ flat bars with ¼″ holes every two inches) which capture and hold the strips flat. A nut is used on each threaded post to hold the retaining plate and strips in place. If one or more strips are damaged and need to be replaced, the nuts, retaining plate and overlapping strips must be removed and the same process reversed after the new strip is added. Because of the number of pieces involved and, in many cases, having to use ladders or lifts at the top of an opening to install, the initial installation of the bracket, individual plastic strips, retainer plates and nuts may be time consuming and difficult for one person.

A variation on this bracket substitutes notched cylindrical posts for the threaded cylindrical posts. In this version, the retaining plates have inverted keyholes that, when placed on the posts, drop into one of the notches. While this design eliminates the need for a nut on each post, it requires one post mounted plastic clip to lock each retaining plate in place. This design still requires individual strips.

Other designs have attempted to eliminate retaining plates, nuts and clips. For example, some systems comprise metal or injection molded plastic brackets with shaped, perpendicular posts. The individual strips include a punched round hole that can be pushed and stretched over a larger diameter round or oval knob to a smaller diameter cylindrical post. While eliminating hardware these designs may not hold the strips flat against the bracket which can create gaps between the strips.

### BRIEF DESCRIPTION OF THE DRAWINGS

It is believed the present invention will be better understood from the following description of certain examples taken in conjunction with the accompanying drawings, in which like reference numerals identify the same elements and in which:

FIG. 1 depicts a perspective view of an exemplary embodiment of a bracket-strip mounting member-strip assembly.

FIG. 2 depicts a front view of the bracket-strip mounting member-strip assembly of FIG. 1.

FIG. 3 depicts a cross-sectional view of the bracket-strip mounting member-strip assembly of FIG. 1.

FIG. 4 depicts a front view of an exemplary embodiment of a strip.

FIG. 4A depicts a detailed view of an exemplary embodiment of a mounting aperture with a slot double punch configuration.

FIG. 5 depicts a top view of an exemplary embodiment of a plurality of overlapping strips.

FIG. 6 depicts a front view of the overlapping strips of FIG. 5.

FIG. 7 depicts a perspective view of an exemplary embodiment of a strip mounting member.

FIG. 8 depicts a front view of the strip mounting member of FIG. 7.

FIG. 9 depicts a side view of the strip mounting member of FIG. 7.

FIG. 10 depicts a perspective view of an exemplary embodiment of a bracket.

FIG. 11 depicts a front view of the bracket of FIG. 10.

FIG. 12 depicts a side view of the bracket of FIG. 10.

FIG. 13 depicts a perspective view of an exemplary strip mounting member-strip assembly.

FIG. 14 depicts a front view of the strip mounting member-strip assembly of FIG. 13.

FIG. 15 depicts a side view of the strip mounting member-strip assembly of FIG. 13.

FIG. 16 depicts a cross-sectional view of the strip mounting member-strip assembly of FIG. 13.

FIG. 16A depicts a cross-sectional view of the strip mounting member-strip assembly of FIG. 13 with welding.

FIG. 17 depicts a perspective view of an exemplary embodiment of a bracket-strip assembly.

FIG. 18 depicts a front view of the bracket-strip assembly of FIG. 17.

FIG. 19 depicts a cross-sectional view of the bracket-strip assembly of FIG. 17.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

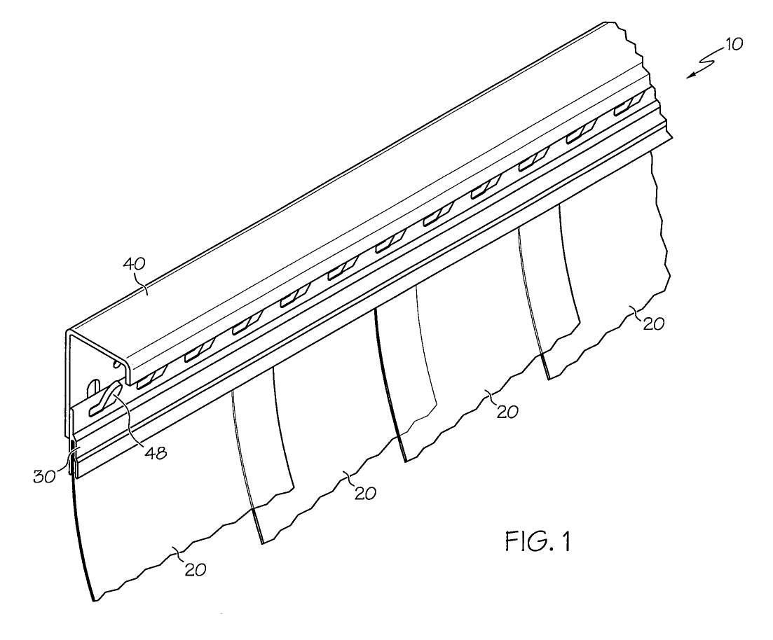

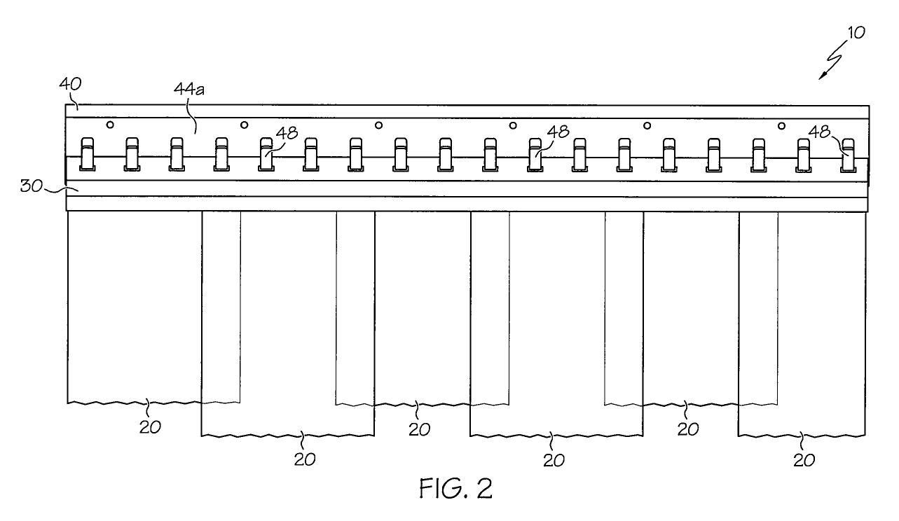

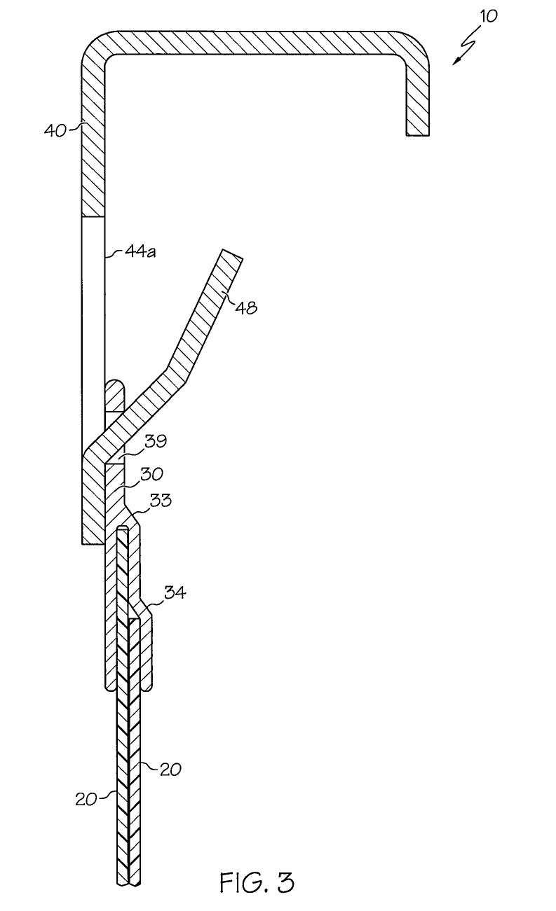

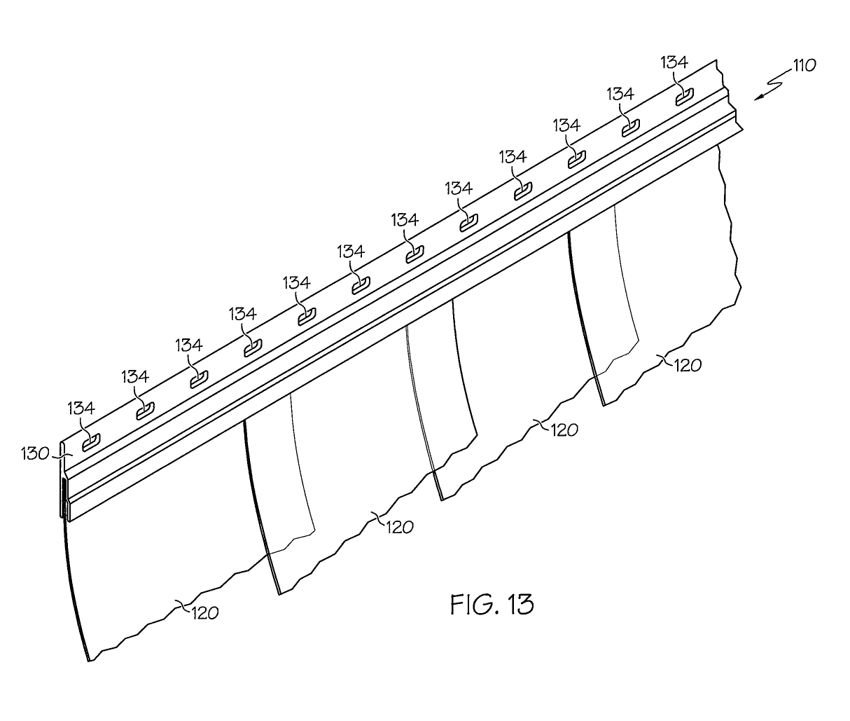

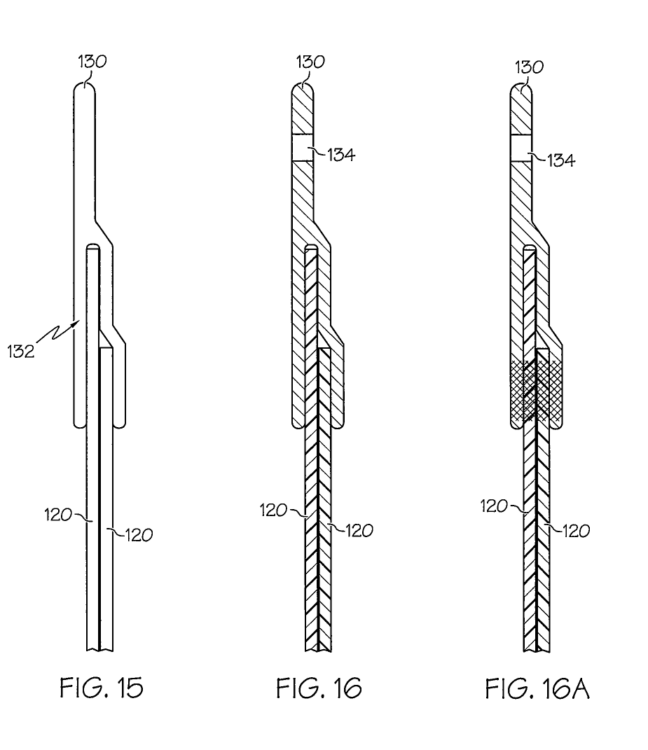

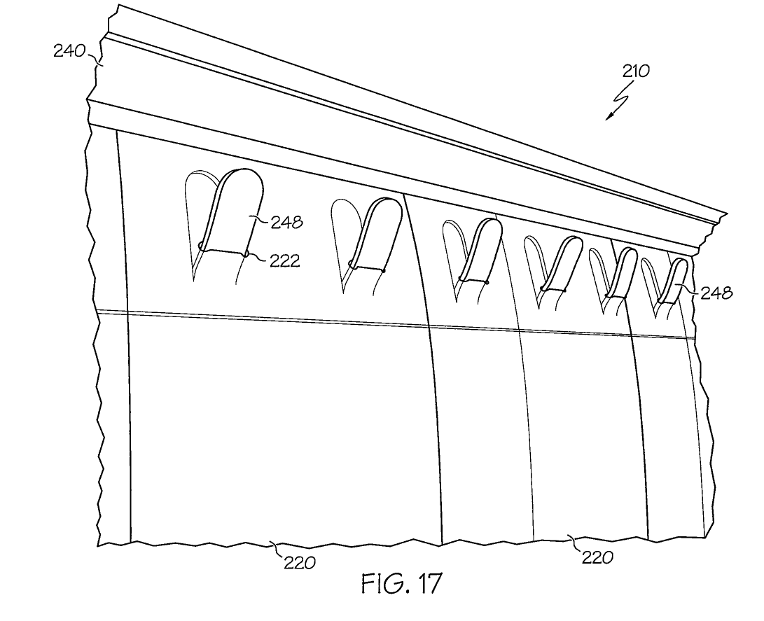

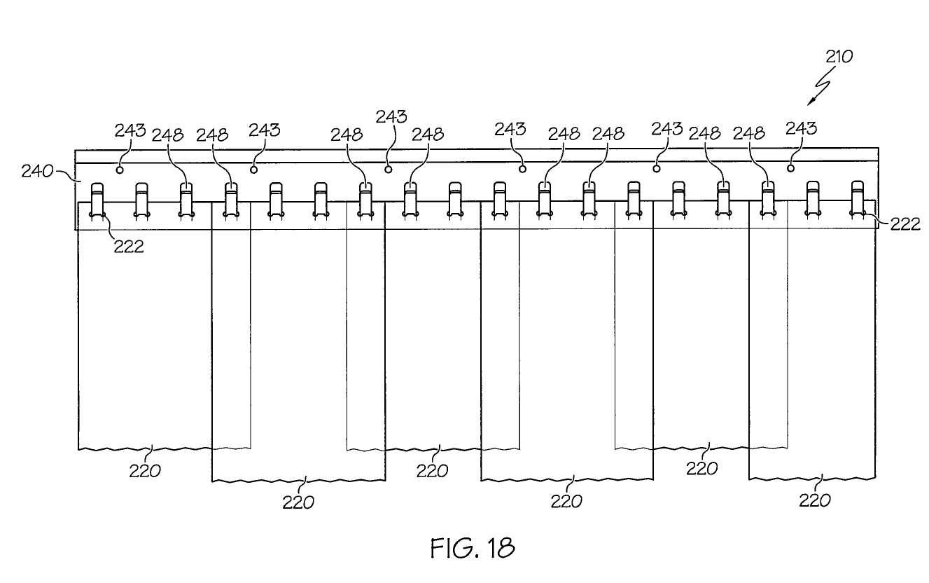

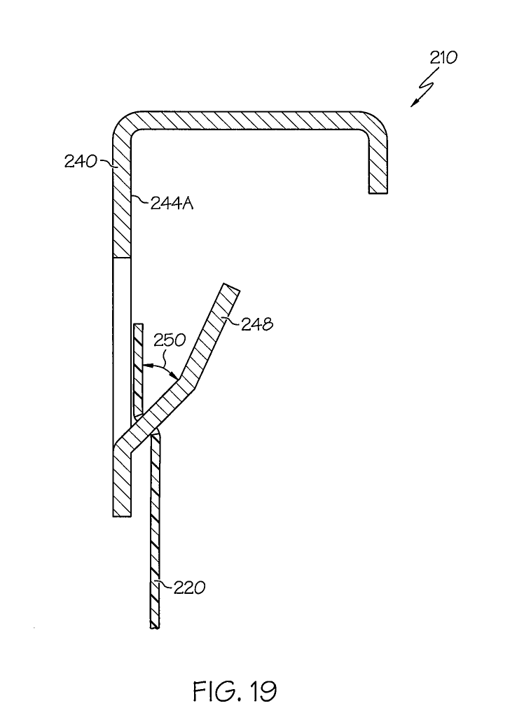

Various embodiments of the present invention may comprise a combination of a strip mounting member, a bracket and/or a plurality of strips. In a first embodiment, shown in FIGS. 1-3, the system comprises a bracket-strip mounting member-strip assembly 10, which may include a plurality of strips 20 attached to a strip mounting member 30 mounted on a bracket 40. In a second embodiment, shown in FIGS. 13-16, the system may comprise a strip mounting member-strip assembly 110, which may include a plurality of strips 120 attached to a strip mounting member 130 along its length. In an alternate embodiment, shown in FIGS. 17-19, the system may comprise a bracket-strip assembly 210, which may include a plurality of strips 220 mounted along the length of a bracket 240.

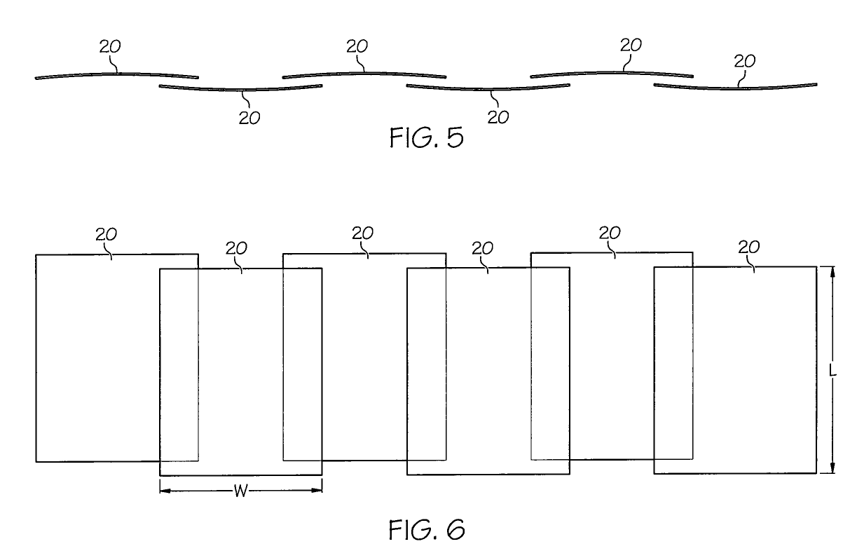

The strips 20, 120, 220 may be clear, translucent, opaque, or have any other suitable visual characteristics. The strips 20, 120, 220 may comprise vinyl, plastic, including, but not limited to, PVC, any other suitable material, or combinations thereof. The strips 20, 120, 220 may be rectangular, square, or have any other suitable configuration. As shown in FIG. 6, each individual strip 20 comprises a width W and a length L. The width W may be about 4 inches, 6 inches, 8 inches, 12 inches, or 16 inches. The length L may correspond to the size of the opening intended to be covered by the system. By way of example only, for an opening approximately seven feet high, the length L may be about 85 inches. Also, by way of example only, for an opening approximately nine feet high, the length L may be about 109 inches. Each strip 20, 120, 220 may also comprise a thickness. The thickness may be about 0.060 inches, 0.080 inches, 0.090 inches, 0.120 inches, or 0.160 inches. However, other suitable width, length and thickness dimensions will be apparent to those skilled in the art. As shown in FIG. 5, the strips 20 may comprise a natural curvature, although this is not required. This curvature may be the result of being rolled under slight pressure. If configured properly, the curvature may provide better initial sealing.

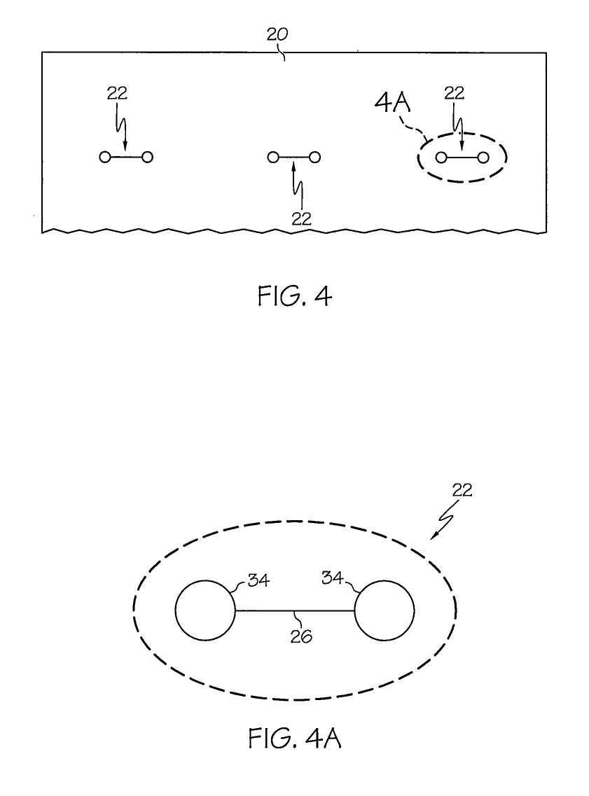

As shown in FIG. 4, the strips 20 include a plurality of bracket mounting apertures 22. Another example of a strip 220 with bracket mounting apertures 222 is shown in FIGS. 17-19. The bracket mounting apertures 22 may be configured to receive the mounting protuberances 48 of the bracket 40. The strips 220 shown in FIGS. 17-19 have been mounted on the bracket 240 by placing mounting projections 248 through bracket mounting apertures 222. The mounting aperture may comprise a slit double hole punch configuration comprising a slit 26 positioned between a pair of punched holes 34, as shown in FIG. 4A. The slit double hole punch configuration may provide an improved seal between strips by helping the strips remain stationary on the mounting protuberances 48, 248 and substantially flat against the inner surface 44a, 244a of the bracket 40, 240. Other suitable configurations for the bracket mounting apertures will be apparent to those skilled in the art. The strip 20 may have any suitable number of bracket mounting apertures 22, and the number of bracket mounting apertures 22 may correspond to the number of mounting protuberances 48 on a bracket 40, but that is not required. The bracket mounting apertures 22 may be arranged and positioned along the strip 20 to correspond to the arrangement and position of the mounting protuberances 48 of the bracket 40. However, this is not required. Bracket mounting apertures 22 may be positioned along the strip 20 with 2 inch spacing between each mounting aperture, but this is not required. It will be appreciated that the bracket mounting apertures are not required. For example, in some embodiments wherein the strips are attached to a strip mounting member, the strips may or may not include one or more bracket mounting apertures.

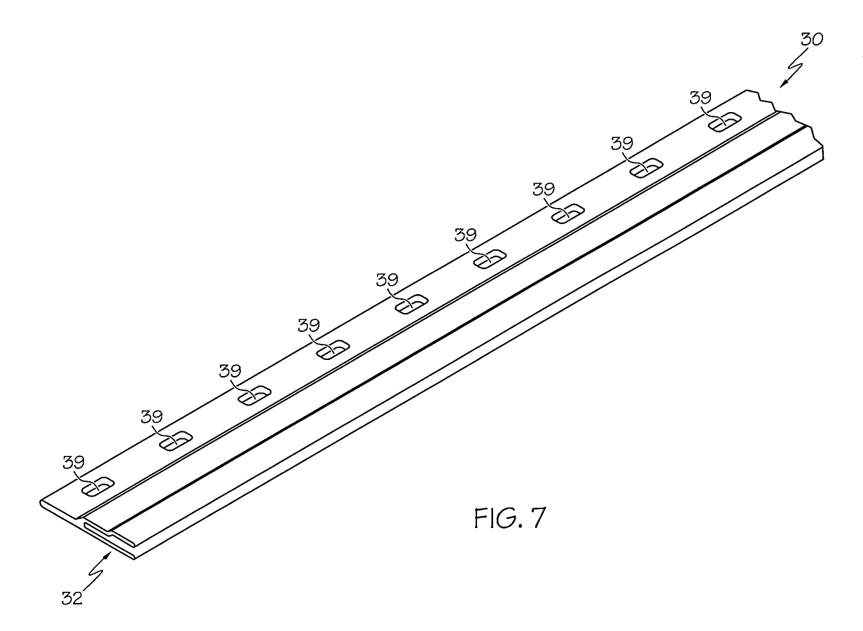

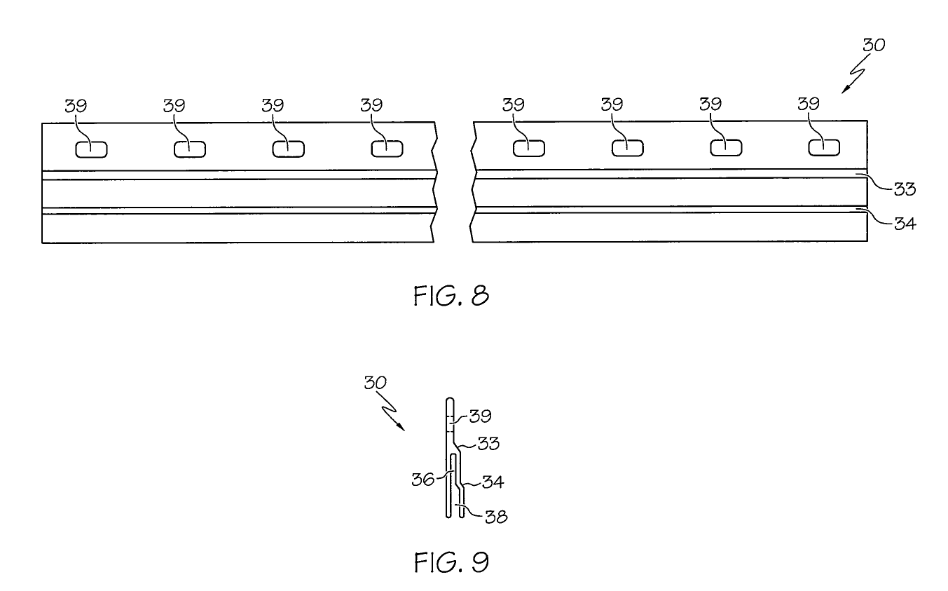

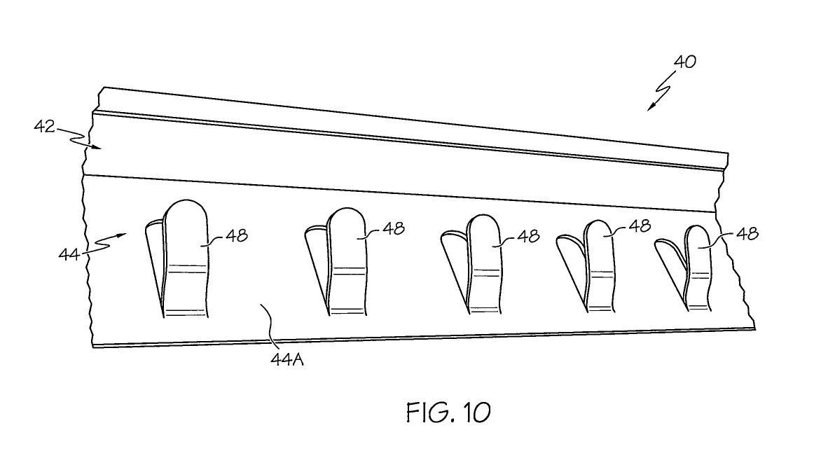

The strip mounting member 30, 130 may comprise rigid plastic, such as, for example PVC, metal, any other suitable material, or combinations thereof. In one embodiment the strip mounting member comprises black, rigid PVC, although this is not required. The material for the strip mounting member 30, 130 may be selected based on the environment the strip mounting member 30, 130 is going to be used in. For instance, certain materials may provide superior qualities for cold environments. In the embodiment shown in FIGS. 7-9, the strip mounting member 30 includes a stepped channel 32 configured to hold a plurality of overlapping or adjacent strips 20, 120. The stepped channel 32 may be molded into the strip mounting member. As shown in FIG. 9, the stepped channel 32 comprises a first step 33, a second step 34, an upper channel 36 and a lower channel 38. Of course, the stepped channel, may comprise a single step, two steps (as shown), or any suitable number of steps. In the illustrated example, the upper channel 36 is configured to receive a first strip. In this version, the lower channel 38 is configured to receive a second strip, such that the second strip may overlap at least a portion of the front surface of the first strip. This is discussed in more detail below. As shown in FIGS. 1-3 and 7-9, the strip mounting member 30 includes a plurality of bracket mounting apertures 39 configured to receive mounting protuberances 48 of a bracket 40. The strip mounting member 30 may have any suitable number of bracket mounting apertures 39, and the number of bracket mounting apertures 39 may correspond to the number of mounting protuberances 48 on a bracket 40, but that is not required. The bracket mounting apertures 39 may be arranged and positioned along the length of the strip mounting member 30 to correspond to the arrangement and positioning of the mounting protuberances 48 of the bracket 40. However, this is not required. Bracket mounting apertures 39 may be positioned along the strip mounting member 30 with 2 inch spacing between each mounting aperture, but this is not required. The strip mounting member may comprise a plurality of surface attachment apertures (not shown), similar to those in the bracket discussed below. The surface attachment apertures may be configured to allow the strip mounting member to be releasably or fixedly attached directly to a support structure, such as a wall, a door frame, or any other suitable structure, without the use of a bracket. The strip mounting member may be releasably or fixedly attached to the support structure utilizing one or more of the following: a screw; a nail; a staple; a clip; an adhesive; any other suitable method or device; and combinations thereof. Embodiments of the strip mounting member may be manufactured in sections 24 inches or 36 inches wide. However, any suitable dimensions may be used depending on the size of the opening to be covered.

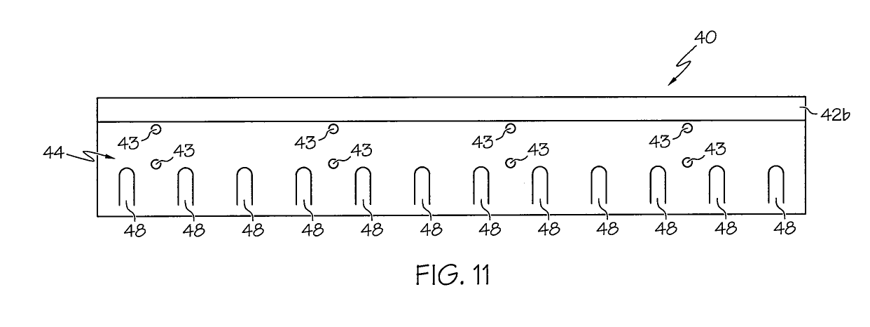

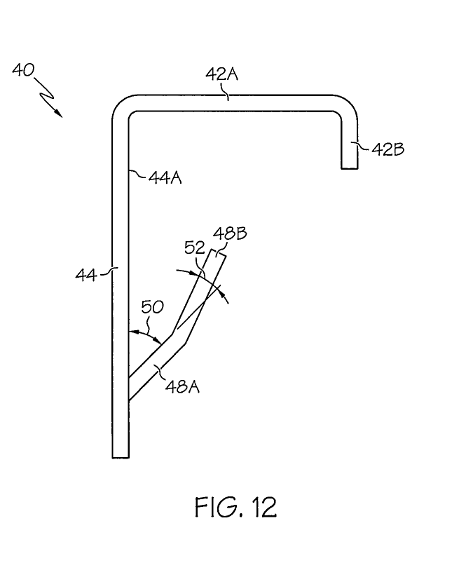

The bracket 40, 240 may be configured utilizing any suitable process, including, but not limited to stamping and forming. The bracket may comprise rigid plastic, metal, such as, by way of example only, aluminum or stainless steel, any other suitable material or combinations thereof. As shown in FIGS. 10-12 the bracket 40 comprises a first attachment member 42 and a second attachment member 44 configured in an L-shaped cross-section. In the illustrated version, first attachment member 42 comprises a horizontal portion 42a and a vertical portion 42b, while second attachment member 44 comprises an inner face 44a. The vertical portion may be configured to provide additional rigidity to the profile of the bracket 40 in order to help maintain a proper shape. As shown, the bracket 40 includes mounting protuberances 48 projecting from inner face 44a and configured to be received by bracket mounting apertures 22 formed in a strip 20 or bracket mounting apertures 39 formed in a strip mounting member 30. The mounting protuberances 48 may have a flat, finger-like shape, as shown in FIGS. 10-12. The flat, finger-like shape may help retain the strips 20 by contacting the surface of the strips and providing a sufficient biasing force towards the inner face 44a of the bracket 40. However, this is not required and any suitable shape may be used. As shown in FIGS. 10-12, each mounting protuberance 48 comprises a lower portion 48a and an upper portion 48b. In the illustrated version, the lower portion 48a projects from the inner face 44a at a first angle 50 and the upper section 48b is bent at a second angle 52. In one embodiment the first angle 50 is 35 degrees and the second angle 52 is 20 degrees. However, other suitable angles for both the first angle and the second angle may be apparent to those of ordinary skill in the art. The mounting protuberances 48 may be configured to reduce unwanted movement of the strips 20 after the strips 20 are placed on the bracket 40. Of course, any suitable number of mounting protuberances may be used. The bracket 40 may comprise one or more surface attachment apertures 43 configured to facilitate attachment of the bracket 40 to a support structure, such as a wall, the inner surface of a door frame, the outer surface of a door frame or any other suitable structure. By way of example only, the one or more surface attachment apertures 43 may be configured such that the bracket 40 may be surface mounted or in-jamb mounted. The bracket 40 may be releasably or fixedly attached to the support structure utilizing one or more of the following: a screw; a nail; a staple; a clip; an adhesive; any other suitable method or device; and combinations thereof.

In the version shown in FIGS. 1-3, bracket-strip mounting member-strip assembly 10 comprises a plurality of strips 20 attached to a strip mounting member 30 mounted on a bracket 40. The bracket-strip mounting member-strip assembly 10 may be positioned above an opening, for example a doorway or window, such that the strips 20 hang in front of the opening. Although the bracket 40 shown in FIGS. 1-3 is configured to support one strip mounting member 30, a bracket may be configured to support any suitable number of strip mounting members 30 and strips 20. The bracket-strip mounting member-strip assembly 10 may be configured in sections of any suitable length. Bracket-strip mounting member-strip assembly 10 may comprise a strip mounting member-strip assembly (shown in FIGS. 13-16A and described below) mounted to a bracket 40. The strip mounting member 30 and the attached strips 10 may be mounted to the bracket 40 without any hardware or tools by passing the mounting protuberances 48 on the bracket 40 through the corresponding bracket mounting apertures 39 in the strip mounting member 30. The bracket-strip mounting member-strip assembly 10 may be configured such that the assembly 10 may be releasably or fixedly attached to a support structure or surface. In such an embodiment, the bracket 40 may comprise surface attachment apertures (as described above) but this is not required. By allowing a user to hang and/or replace multiple strips 20 at the same time, the bracket-strip mounting member-strip assembly 10 may reduce the labor associated with hanging and/or replacing individual strips 20.

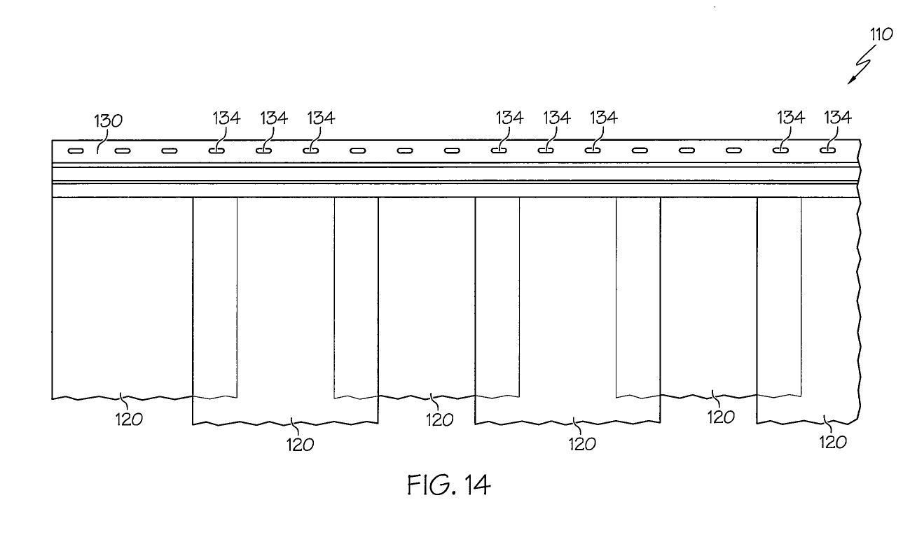

As shown in FIGS. 13-16A, a strip mounting member-strip assembly 110 comprises a plurality of strips 120 placed within the stepped channel 132 and attached to the strip mounting member 130. The strip mounting member-strip assembly 110 may be positioned above an opening, for example a doorway or window, such that the strips 120 hang in front of the opening. As shown in FIG. 14, the strips 120 are positioned such that adjacent strips 120 overlap at least a portion of each other. The strips 120 may be attached to the strip mounting member 130 using any suitable method or device, including, but not limited to thermal welding and radio frequency welding. FIG. 16A depicts a side view of the strip mounting member-strip assembly 110 where the strips 120 have been welded to the strip mounting member 130. The strip mounting member-strip assembly 110 may be configured in sections of any suitable length, including, but not limited to lengths of two feet and three feet. The strip mounting member 130 may be configured to receive any suitable number of strips 120. The strip mounting member-strip assembly 110 may be configured such that the assembly 110 may be releasably or fixedly attached to a support structure or surface without a bracket. In such an embodiment, the strip mounting member 130 may comprise any suitable number of surface attachment apertures 134, which may be similar to the surface attachment apertures 43 described above or have any other suitable configuration. However, these surface attachment apertures are not required. This particular embodiment may reduce both the time required for initial installation and replacement and lower the cost because it does not require the use of a bracket.

In the version shown in FIGS. 17-19, a bracket-strip assembly 210 comprises a plurality of strips 220 mounted on a bracket 240. The plurality of strips 220 may be fixedly or releasably mounted on the bracket 240. In this embodiment, the strips 220 comprise a plurality of bracket mounting apertures 222 configured to receive the mounting protuberances 248. As discussed above, the bracket mounting apertures 222 may comprise a slit double hole punch configuration. Also, as discussed above, the mounting protuberances 248 may be bent out from the inner face 244a of the bracket 240 at a first angle 250 forming a V shape when observed from the side of the bracket 240. The first angle 250 may comprise 45 degrees or any other suitable angle. The mounting protuberances 248 may be configured to allow for the automatic adjustment for strip thickness. The bracket-strip assembly 210 may be configured to offer the advantage of automatic strip thickness adjustment for improved strip overlap sealing. Accordingly, the assembly 210 may be configured to allow for the installation of strips 220 with a thickness ranging from about 0.060 inches to about 0.250″ without requiring any adjustments to the bracket 240 or mounting protuberances 248. The bracket may comprise surface mounting apertures 243, which may be similar to surface mounting apertures 43 described above or have any other suitable configuration.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometries, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

What is claimed is:

1. A modular strip door system comprising:
(a) a plurality of strips;
(b) a bracket, wherein the bracket comprises:
(i) a first attachment member, wherein the first attachment member is configured to facilitate attachment of the bracket to a support structure,
(ii) a second attachment member, wherein the second attachment member is configured to facilitate attachment of the bracket to a support structure, wherein the second attachment member is positioned adjacent and perpendicular to the first attachment member, wherein the second attachment member comprises an inner face, and
(iii) at least one mounting protuberance, wherein the at least one mounting protuberance projects from the inner face; and
(c) a strip mounting member, wherein the strip mounting member is configured to be releasably mounted on the bracket, wherein the strip mounting member comprises:
(i) at least one bracket mounting aperture, wherein the at least one mounting aperture is configured to receive the at least one mounting protuberance,
(ii) an upper channel, wherein the upper channel is configured to receive a first strip of the plurality of strips, and
(iii) a lower channel, wherein the lower channel is configured to receive a second strip of the plurality of strips, wherein the lower channel is configured to allow the second strip of the plurality of strips to at least partially overlap a portion of the first strip of the plurality of strips.

2. The modular strip door system of claim 1, wherein the plurality of strips comprise substantially rectangular members.

3. The modular strip door system of claim 1, wherein the plurality of strips comprise a material, wherein the material is selected from the group consisting of plastic, poly vinyl chloride, and combinations thereof.

4. The modular strip door system of claim 1, wherein the at least one mounting protuberance comprises a lower portion and an upper portion, wherein the lower portion projects from the inner face at a first angle, wherein the upper portion is bent at a second angle.

5. The modular strip door system of claim 1, wherein the number of mounting protuberances corresponds to the number of bracket mounting apertures.

6. The modular strip door system of claim 1, wherein the bracket further comprises at least one surface attachment aperture, wherein the at least one surface attachment apertures is configured to allow a user to attach the bracket to a support structure.

7. The modular strip door system of claim 1, wherein the bracket is releasably attached to the support structure.

8. The modular strip door system of claim 1, wherein the support structure is selected from the group consisting of a wall, an outer surface of a door frame, an inner surface of a door frame, and combinations thereof.

9. The modular strip door system of claim 1, wherein the strip mounting member is an extruded member.

10. The modular strip door system of claim 1, wherein the strip mounting member comprises a material, wherein the material is selected from the group consisting of plastic, poly vinyl chloride, metal, and combinations thereof.

11. The modular strip door system of claim 1, wherein the first strip of the plurality of strips is fixedly attached to the strip mounting member using a process selected from the group consisting of thermal welding, radio frequency welding, and combinations thereof, wherein the second strip of the plurality of strips is fixedly attached to the strip mounting member using a process selected from the group consisting of thermal welding, radio frequency welding, and combinations thereof.

12. A modular strip door system comprising:
(a) a plurality of strips; and
(b) a strip mounting member, wherein the strip mounting member is configured to be attached to a support structure, wherein the strip mounting member comprises:
(i) at least one surface attachment aperture, wherein the at least one surface attachment aperture is configured to facilitate attachment of the strip mounting member to the support structure,
(ii) an upper channel, wherein the upper channel is configured to receive a first strip of the plurality of strips, and
(iii) a lower channel, wherein the lower channel is configured to receive a second strip of the plurality of strips, wherein the lower channel is configured to allow the second strip of the plurality of strips to overlap at least a portion of the first strip of the plurality of strips.

13. The modular strip door system of claim 12, wherein the plurality of strips comprise a material, wherein the material is selected from the group consisting of plastic, poly vinyl chloride, and combinations thereof.

14. The modular strip door system of claim 12, wherein the strip mounting member is an extruded member.

15. The modular strip door system of claim 12, wherein the first strip of the plurality of strips is fixedly attached to the strip mounting member using a process selected from the group consisting of thermal welding, radio frequency welding, and combinations thereof, wherein the second strip of the plurality of strips is fixedly attached to the strip mounting member using a process selected from the group consisting of thermal welding, radio frequency welding, and combinations thereof.

16. A modular strip door system comprising;
(a) a bracket, wherein the bracket comprises:
(i) a first attachment member, wherein the first attachment member is configured to facilitate attachment of the bracket to a support structure,
(ii) a second attachment member, wherein the second attachment member is configured to facilitate attachment of the bracket to a support structure, wherein the second attachment member is positioned adjacent and perpendicular to the first attachment member, wherein the second attachment member comprises an inner face, and
(iii) at least one mounting protuberance, wherein the at least one mounting protuberance projects from the inner face; and
(b) a plurality of strips, wherein each of the plurality of strips comprises at least one bracket mounting aperture, wherein the at least one bracket mounting aperture is configured to receive the at least one mounting protuberance;
wherein the plurality of strips are positioned along the length of the bracket such that each of the plurality of strips alternately overlaps at least a portion of an adjacent strip.

17. The modular strip door system of claim 16, wherein the at least one bracket mounting aperture comprises a slit double hole punch configuration.

18. The modular strip door system of claim 16, wherein the at least one mounting protuberance comprises a lower portion and an upper portion, wherein the lower portion projects from the inner face at a first angle, wherein the upper portion is bent at a second angle.

19. The modular strip door system of claim 18, wherein the first angle is about 45 degrees.

20. The modular strip door system of claim 16, wherein the at least one mounting protuberance comprises a flat, finger-like configuration.
